(19) United States
(12) Patent Application Publication
(10) Pub. No.: US 2015/0304562 A1
(43) Pub. Date: Oct. 22, 2015

(54) IMAGING APPARATUS AND CONTROL METHOD THEREOF

(71) Applicant: SAMSUNG ELECTRO-MECHANICS CO., LTD., Suwon-Si (KR)

(72) Inventors: Sang Min On, Suwon-Si (KR); Sung Ryung Park, Suwon-Si (KR); Soo Cheol Lim, Suwon-Si (KR); Byung Woo Kang, Suwon-Si (KR); Chul Jin Kim, Suwon-Si (KR)

(73) Assignee: SAMSUNG ELECTRO-MECHANICS CO., LTD., Suwon-Si (KR)

(21) Appl. No.: 14/259,059

(22) Filed: Apr. 22, 2014

(51) Int. Cl. H04N 5/232; H04N 5/235

(52) U.S. Cl. CPC H04N 5/23287; H04N 5/23267; H04N 5/2352

(57) ABSTRACT

An imaging apparatus including an imaging unit, a lens transferring means, and an image processing device. The image processing device may include a controlling unit, an illuminance sensing unit, an image storing unit, an image processing unit, a noise removing unit, a memory, and a displaying unit. Therefore, hand shaking at the time of capturing an image may be compensated for by the lens transferring means, and an exposure time may be compensated for by synthesizing luminance information of several images with the image processing device, whereby a clear image may be obtained even in a low luminance environment.

### BACKGROUND

The present disclosure relates to an imaging apparatus and a control method thereof.

A digital image processing device such as a mobile phone, a digital camcorder, a personal digital assistant, or the like, in which a digital camera and a camera module are mounted records a form of a subject using an image sensor such as a charge coupled device (CCD) or a complementary metal-oxide semiconductor (CMOS), converting light data incident through a lens into electrical signals.

The digital image processing device generally has a problem that blurry image, due to of hand shake, may be captured because of an increase in shutter speed at the time of performing imaging in a low luminance environment in which an amount of light is insufficient.

That is, a shutter speed is generally increased in order to increase visibility of a imaged object in a low luminance imaging environment such as during the night, such that motion blur may occur due to shaking of an image capturing device.

Therefore, research into a technology of preventing motion blur from occurring in an image captured in a low luminance imaging environment and allowing a clear image to be obtained has been required.

### SUMMARY

An aspect of the present disclosure may provide an imaging apparatus capable of obtaining a clear image even in a low luminance imaging environment, and a control method thereof.

An imaging apparatus according to an exemplary embodiment of the present disclosure may include an imaging unit, a lens transferring means, and an image processing device.

The lens transferring means of the imaging apparatus may move at least one of a lens or an image sensor to compensate for user hand shake.

The imaging apparatus may compensate for the hand shake at the time of capturing an image by the lens transferring means and compensate for an exposure time by synthesizing luminance information of several images with the image processing device.

In a control method of an imaging apparatus according to an exemplary embodiment of the present disclosure, a shutter speed of set imaging conditions may be compared with a preset shutter speed to selectively capture a single image or a plurality of images for a subject, and luminance information may be extracted from the plurality of images, totaled and a single image to which the totaled luminance information is applied may be generated in the case in which the plurality of images are captured.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram of an imaging apparatus according to an exemplary embodiment of the present disclosure; and

FIG. 2 is a flow chart schematically showing a control method of an imaging apparatus according to an exemplary embodiment of the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

Throughout the drawings, the same reference numerals will be used to designate the same or like elements.

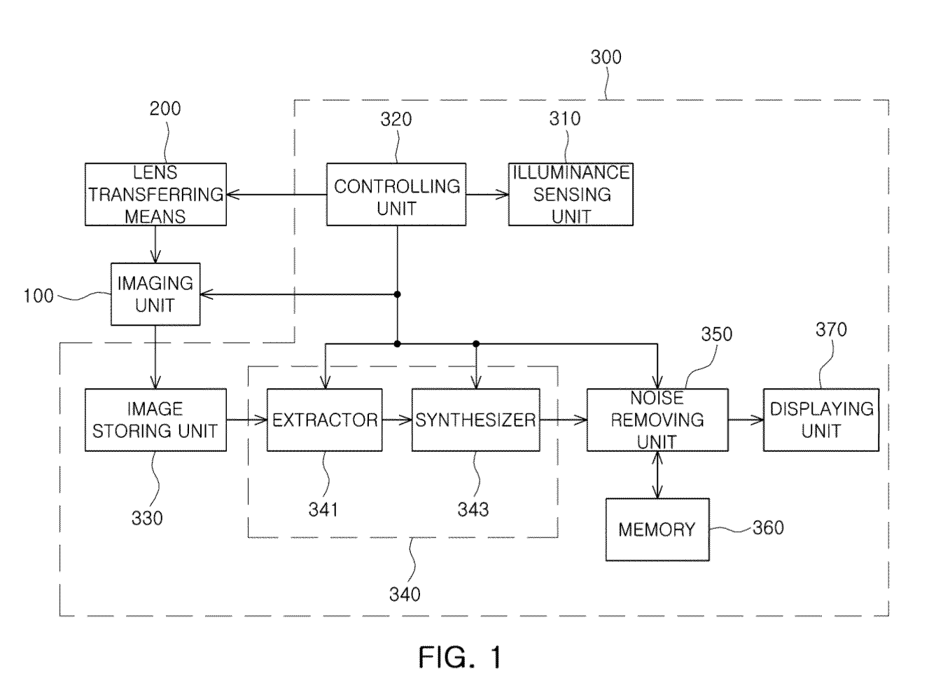

FIG. 1 is a block diagram of an imaging apparatus according to an exemplary embodiment of the present disclosure.

An imaging apparatus according to an exemplary embodiment of the present disclosure may be used in a portable phone, a portable computer, a portable electronic dictionary, a personal digital assistant, a portable media player, and the like.

Referring to FIG. 1, the imaging apparatus according to an exemplary embodiment of the present disclosure may include an imaging unit 100, a lens transferring means 200, and an image processing device 300.

The imaging unit 100 may include a lens and a stop.

The lens may be to capture an image of a subject, light passing through the lens may be collected by an image sensor and be stored as data on a memory, and the stored data may be displayed as an image through a displaying unit.

The stop may indicate a device adjusting an amount of light passing through the lens, and a size of the stop may be represented by a value of F.

The lens transferring means 200 may be a hand shake compensating device for compensating for hand shake, or the like, of a user imaging the subject.

In detail, the lens transferring means 200 may be an optical image stabilizer (OIS) moving the lens or the image sensor to allow the same image to be formed at a predetermined position even though the hand shake occurs.

The compensation for the hand shake by the imaging apparatus according to an exemplary embodiment of the present disclosure may be implemented by detecting a magnitude and a direction of the hand shake by a gyroscope (not shown), calculating a moving direction the lens or the image sensor capable of compensating for the detected magnitude and direction of the hand shake by a controlling unit, and driving the lens transferring means 200 depending on a compensation movement magnitude and a compensation movement direction calculated by the controlling unit to move the lens or the image sensor.

This compensation for the hand shake may be useful particularly in a low luminance imaging environment in which it is difficult to secure an exposure time required for obtaining a clear image. The reason is that an image of the subject is significantly affected even by slight handshake of the user in the illuminance imaging environment.

The image processing device 300 may display the imaged image of the subject through a displaying unit 370 and sense the user hand shake to command the lens transferring means 200 to compensate for the hand shake.

Meanwhile, the image processing device 300 may include a controlling unit 320, an illuminance sensing unit 310, an image storing unit 330, an image processing unit 340, a noise removing unit 350, a memory 360, and the displaying unit 370.

The illuminance sensing unit 310 may measure an illuminance level of an imaging environment and transmit a measured illuminance value to the controlling unit 320.

Here, the controlling unit 320 may judge whether a current imaging environment is a high illuminance imaging environment (for example, an environment having an illuminance level of 1001ux or more) or a low imaging illuminance environment (for example, an environment having an illuminance less than 1001ux) based on the illuminance value received from the illuminance sensing unit 310.

The controlling unit 320 may set imaging conditions based on information on the illuminance value.

For example, in the case in which it is judged that the current imaging environment is the low luminance imaging environment, the controlling unit 320 may set the imaging conditions so that a shutter speed is 1/10 of a second or more to ½ of a second or less.

The above-mentioned imaging conditions are is only by way of example, and may be variously changed depending on the imaging environment.

Under such imaging conditions, the controlling unit 320 may transmit a control signal to the lens transferring means 200, and the lens transferring unit 200 may move the lens or the image sensor to compensate for the user hand shake.

Here, in the case in which a shutter speed is to be increased in order to secure sufficient exposure in the low luminance imaging environment, even though the lens or the image sensor is moved by the lens transferring means 200, it may be difficult to obtain a clear image of the subject.

Therefore, the image processing device 300 included in the imaging apparatus according to an exemplary embodiment of the present disclosure may store several images, extract luminance information from the several images, and synthesize the extracted luminance information to compensate for an exposure time, thereby obtaining a clear image even in the low luminance imaging environment.

That is, the imaging apparatus according to an exemplary embodiment of the present disclosure may compensate for the hand shake by the lens transferring means 200 and compensate for the exposure time by synthesizing the several images with the image processing device 300, thereby obtaining a clearer image.

The controlling unit 320 may transmit the control signal to the imaging unit 100 so as to decrease a shutter speed (for example, ½ second or less) and capture several images (for example, 5 images) at a short shutter speed, in the low luminance imaging environment in which the shutter speed is to exceed a preset shutter speed (for example, 1 second).

In this case, hand shake for the several captured images may be compensated for by the lens transferring means 200.

The several captured images may be output as analog image signals from the image sensor, and may be converted into digital image signals by an analog to digital (A/D) converter.

The image storing unit 330 may store digital image signals for the several captured images therein.

The image processing unit 340 may include an extractor 341 and a synthesizer 343, wherein the extractor 341 may extract the respective luminance information from the digital image signals for the respective images transferred from the image storing unit 330.

The synthesizer 343 may add the respective extracted luminance information to compensate for the exposure time.

In addition, the synthesizer 343 may synthesize the compensated luminance information to the digital image signal to generate a digital image signal for one image.

That is, in the low luminance imaging environment, the shutter speed is shortened to capture several images, and luminance information is extracted from image signals for the several captured images and is totaled, whereby a sufficient exposure time may be secured in spite of a short shutter speed.

In the imaging apparatus according to an exemplary embodiment of the present disclosure, the user hand shake at a moment at which the subject is captured may be compensated for by the lens transferring unit 200, and the luminance information may be extracted from the several images captured at a short shutter speed and be totaled with the image processing unit 340 to secure the sufficient exposure time, such that a high quality clear image may be obtained in the low luminance imaging environment.

The digital image signal synthesized by the image processing unit 340 may be stored in the memory 360, and the noise removing unit 350 may remove noise from the digital image signal stored in the memory 360 and output the digital image signal from which the noise is removed to the displaying unit 370.

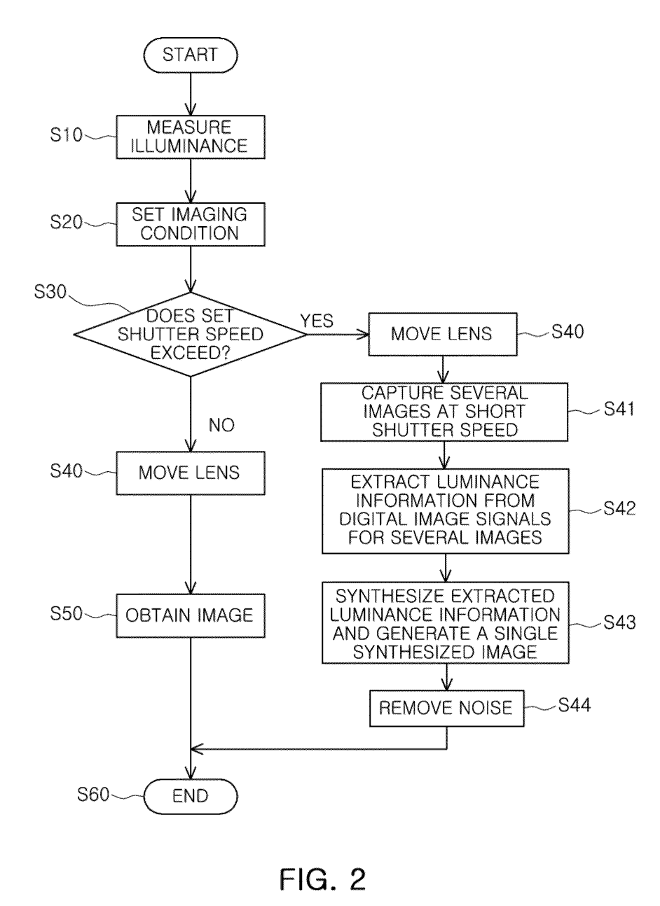

FIG. 2 is a flow chart schematically showing a control method of an imaging apparatus according to an exemplary embodiment of the present disclosure.

A control method of an imaging apparatus according to an exemplary embodiment of the present disclosure will be described with reference to FIG. 2.

An imaging mode may start by selection of a user or an input signal.

When the imaging mode starts, the illuminance sensing unit 310 may measure an illuminance level of an imaging environment and transmit information on the measured illuminance to the controlling unit 320 (S10).

The controlling unit 320 may set imaging conditions based on the received illuminance (S20) information.

Here, when it is judged that the imaging conditions does not exceed a preset shutter speed (S30), user handshake at the time of performing imaging may be compensated for through the lens transferring means 200 (S40), and a captured image may be obtained (S50).

Then, when an operation of the imaging apparatus ends by the user, a current imaging mode may end (S60).

Unlike this, when it is judged that the imaging conditions exceeds the preset shutter speed (S30), the user hand shake at the time of performing the imaging may be compensated for through the lens transferring means 200 (S40), and several images may be captured at a short shutter speed (S41).

Then, the extractor 341 of the image processing unit 340 may extract luminance information from digital image signals for the several captured images (S42).

The extracted luminance information may be totaled with the synthesizer 343 of the image processing unit 340, such that the exposure time may be compensated for, and the compensated luminance information may be synthesized to the digital image signal to generate a single synthesized image (S43).

Noise may be removed from the single synthesized image by the noise removing unit 350 (S44).

Then, when an operation of the imaging apparatus ends by the user, a current imaging mode may end (S60).

With the imaging apparatus and the control method thereof according to an exemplary embodiment of the present disclosure as described above, the user hand shake at a moment at which the subject is captured may be compensated for by the lens transferring unit 200, and the luminance information may be extracted from the several images captured at a short shutter speed and be totaled with the image processing unit 340 to secure the sufficient exposure time, such that a high quality clear image may be obtained in the low luminance imaging environment as well as in the high illuminance imaging environment.

As set forth above, according to exemplary embodiments of the present disclosure, a clear image may be obtained even in a low luminance imaging environment.

While exemplary embodiments have been shown and described above, it will be apparent to those skilled in the art that modifications and variations could be made without departing from the spirit and scope of the present disclosure as defined by the appended claims.

What is claimed is:

1. An imaging apparatus comprising:
an imaging unit selectively imaging one image or a plurality of images for a subject depending on imaging conditions set according to an illuminance level of an imaging environment;
a lens transferring means selectively moving a lens to compensate for hand shaking, when the subject is captured; and
an image processing device adding luminance information on the plurality of images and generating one image to which the totaled luminance information is applied, in the case in which the imaging unit captures the plurality of images.

2. The imaging apparatus of claim 1, wherein a controlling unit transmits a control signal to the imaging unit so as to capture the plurality of images for the subject in the case in which the illuminance level of the imaging environment is a reference illuminance or less and transmits a control signal to the imaging unit so as to capture one image for the subject in the case in which the illuminance level of the imaging environment exceeds the reference illuminance.

3. The imaging apparatus of claim 1, wherein in the case in which the imaging unit captures the plurality of images, the lens transferring means performs the compensation for hand shaking whenever the respective images are captured.

4. The imaging apparatus of claim 1, wherein the image processing device extracts luminance information from digital image signals for the plurality of captured images and synthesizes the extracted luminance information to generate a digital image signal for one image.

5. The imaging apparatus of claim 1, wherein the image processing device includes:
a image storing unit storing digital image signals for the plurality of captured images therein;
an extractor extracting luminance information from the digital image signals for the respective images transferred from the image storing unit; and
a synthesizer adding the luminance information extracted by the extractor and applying the totaled luminance information to generate a digital image signal for one image.

6. The imaging apparatus of claim 5, wherein the image processing device further includes a memory in which the digital image signal for one image is stored.

7. The imaging apparatus of claim 6, wherein the image processing device further includes a noise removing unit removing noise from the digital image signal for one image stored in the memory.

8. A control method of an imaging apparatus, comprising:
measuring an illuminance level of an imaging environment;
setting imaging conditions from the illuminance level of the imaging environment;
comparing a shutter speed of the set imaging condition with a preset shutter speed;
selectively imaging one image or a plurality of images for a subject while performing compensation for hand shaking depending on a comparison result; and
ending the imaging in the case in which one image is captured in the selective imaging and generating a single synthesized image from the plurality of images and then ending the imaging in the case in which the plurality of images are captured in the selective imaging.

9. The control method of an imaging apparatus of claim 8, wherein the generating of the single synthesized image includes:
extracting luminance information from the plurality of images; and
adding the extracted luminance information and generating a single image to which the totaled luminance information is applied.
